(19) United States
(12) Patent Application Publication
(10) Pub. No.: US 2009/0112800 A1
(43) Pub. Date: Apr. 30, 2009

(54) SYSTEM AND METHOD FOR VISUAL CONTEXTUAL SEARCH

(76) Inventor: Athellina Rosina Ahmad Athsani, San Jose, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(21) Appl. No.: 11/924,784

(22) Filed: Oct. 26, 2007

(51) Int. Cl. G06F 7/06

(52) U.S. Cl. 707/3; 707/E17.019

(57) ABSTRACT

The present invention is directed towards systems, methods, and computer readable media for searching and retrieving one or more visual representations and contextual data associated with a given object and one or more constituent components of the object. The method of the present invention comprises receiving a first query identifying a given object. One or more visual representations and one or more items of contextual data corresponding to the given object are identified, and the one or more identified visual representations corresponding to the given object are displayed in conjunction with the one or more identified items of contextual data. A second query identifying a constituent component within the given object is received, and one or more visual representations of the constituent component are identified and displayed in conjunction with one or more items of contextual data corresponding to the constituent component.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention generally provides methods and systems for allowing users to retrieve visual representations and contextual data for any predefined object. More specifically, the present invention provides methods and systems that facilitate the search and retrieval of visual representations of objects, by either entering a search query for the object, or by transmitting a digital image of the object. The user may then search for individual components within the constraints of the object and retrieve visual representations and contextual data for the individual components of the object.

A number of techniques are known to those of skill in the art for searching and retrieving visual representations of objects along with contextual information. Providers of traditional internet search technology maintain web sites that return links to visual representations content after a query by the user. For example, a 3D warehouse may provide users with the ability to browse and download three-dimensional models of objects. However, traditional search providers of object-based content are limited, in that each provider only allows users to search over a given provider's library of three-dimensional objects, without any ability to search within the objects themselves, and without any ability to provide relevant contextual data, such as promotional advertising. Additionally, traditional search providers do not utilize image recognition technology to enable the recognition of an object within a two-dimensional image, and retrieve a visual representation of the object.

In order to overcome shortcomings and problems associated with existing apparatuses and techniques for searching and retrieving object content, embodiments of the present invention provide systems and methods for searching and retrieving visual representations and contextual data for objects defined in a query or received as a two-dimensional image file from a digital device, including visual representations and contextual data regarding the components of the object.

### SUMMARY OF THE INVENTION

The present invention is directed towards methods, systems, and computer readable media comprising program code for searching and retrieving one or more visual representations and contextual data associated with a given object and one or more constituent components of the object. The method of the present invention comprises receiving a first query identifying a given object. According to one embodiment of the present invention, the first query comprises receiving one or more terms identifying a given object. In an alternate embodiment, the first query comprises receiving an image from a mobile device identifying a given object.

The method of the present invention further comprises identifying one or more visual representations and one or more items of contextual data corresponding to the given object, and displaying the one or more identified visual representations corresponding to the given object in conjunction with the one or more identified items of contextual data. According to one embodiment of the present invention, one or more visual representations comprise at least one of a three-dimensional view, blueprint view, x-ray view, outline view, three-dimensional rendering, and surface view. The contextual data may comprise at least one of historical information, specification information, encyclopedic information, and advertising information.

The method of the present invention further comprises receiving a second query identifying a constituent component within the given object. One or more visual representations of the constituent component are identified and displayed in conjunction with one or more items of contextual data corresponding to the constituent component. According to one embodiment of the present invention, identifying and displaying one or more visual representations of the constituent component comprises identifying the constituent component within the visual representation of the given object, and displaying the identified constituent component in a distinguishing manner.

The system of the present invention comprises an image server component operative to store one or more visual representations corresponding to one or more objects and one or more visual representations corresponding to one or more constituent components within the one or more objects. According to one embodiment of the present invention, the image server component is operative to look for and store one or more visual representations comprising at least one of a three-dimensional view, blueprint view, x-ray view, outline view, three-dimensional rendering, and surface view.

The system further comprises a contextual server component operative to store one or more items of contextual data corresponding to the one or more objects and one or more items of contextual data corresponding to the one or more constituent components the one or more objects. According to one embodiment of the present invention, the contextual server component is operative look for and store contextual data comprising at least one of historical information, specification information, encyclopedic information, and advertising information.

The system further comprises a search server component operative to receive a first query identifying a given object, and retrieve and display one or more visual representations corresponding to the given object from the image server and one or more items of contextual data corresponding to the given object from the contextual server. The search server component is further operative to receive a second query identifying a constituent component within the given object, and retrieve and display one or more visual representations corresponding to the constituent component from the image server and one or more items of contextual data corresponding to the constituent component from the contextual server. According to one embodiment of the present invention, the search server component is operative to receive a first query comprising one or more terms identifying a given object. In an alternate embodiment, the search server component is operative to receive a first query comprising an image from a mobile device identifying a given object.

According to one embodiment of the present invention, the search server component is operative to identify a constituent component within the visual representation of the given object and retrieve one or more visual representations corresponding to the constituent component from the image server and one or more items of contextual data corresponding to the constituent component from the contextual server. The search server is operative to thereafter display the identified constituent component in a distinguishing manner.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1A is a block diagram presenting a system for searching and retrieving visual representations or views and associated contextual data from a client device, according to one embodiment of the present invention;

FIG. 1B is a block diagram presenting a system for searching and retrieving visual representations or views and associated contextual data from a captured digital image, according to one embodiment of the present invention;

FIG. 2 is a flow diagram presenting a method for identifying an object and retrieving one or more available representations or views and contextual data associated with the identified object, according to one embodiment of the present invention;

FIG. 3 is a flow diagram presenting a method for searching for one or more components within a given object, according to one embodiment of the present invention;

FIG. 4 is a flow diagram presenting a method for identifying one or more components or ingredients comprising a given food object, according to one embodiment of the present invention;

FIG. 5 is a flow diagram presenting a method for web-based searching functionality embedded within an object-based search according to one embodiment of the present invention; and

FIG. 6 is a flow diagram presenting method for retrieving and displaying location-matching representations or views and contextual data, according to one embodiment of the present invention.

### DETAILED DESCRIPTION OF THE PREFERRED EMBODIMENT

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

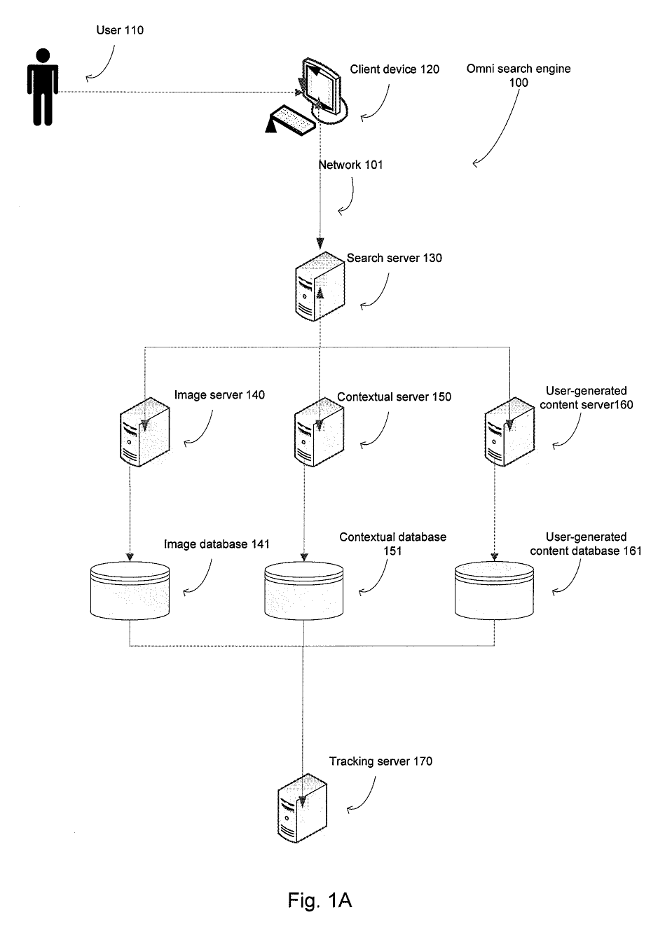

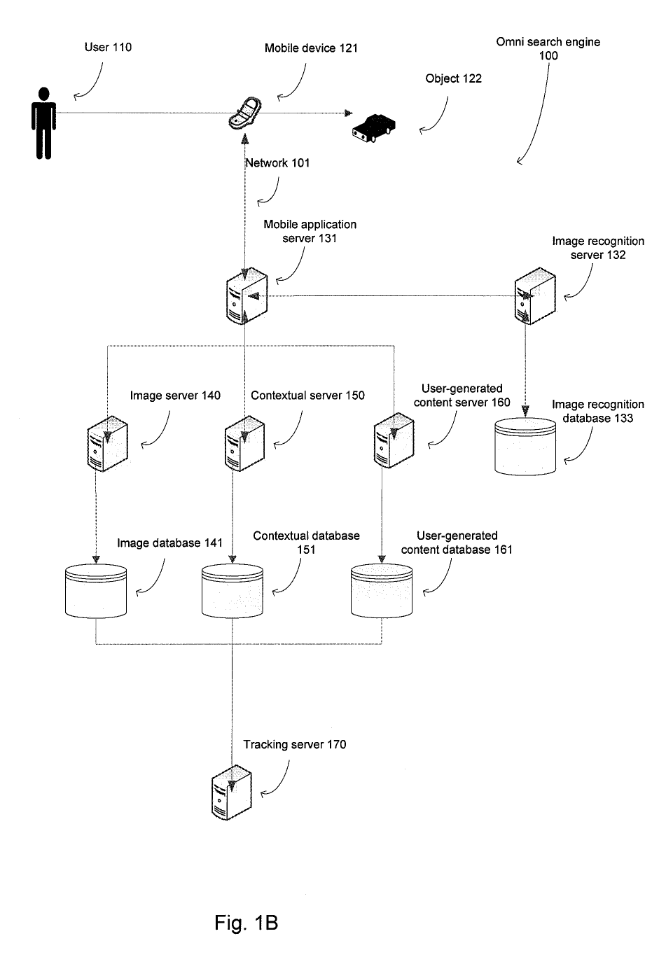

FIG. 1A presents a block diagram illustrating one embodiment of a system for searching and retrieving content associated with a given object, including, but not limited to visual representations or views, blueprints, component data, and advertising information. According to the embodiment of FIG. 1A, an Omni search engine 100 comprises one or more software and hardware components to facilitate searching and accessing object content including, but not limited to, a client device 120, a search server 130, an image server 140, an image database 141, a contextual server 150, a contextual database 151, a user-generated content server 160, a user-generated content database component 161, and a tracking server 170.

The Omni search engine 100 is communicatively coupled with a network 101, which may include a connection to one or more local and/or wide area networks, such as the Internet. A user 110 of a client device 120 initiates a web-based search, such as a query comprising one or more terms. The client device 120 passes the search request through the network 101, which can be either a wireless or hard-wired network, for example, through an Ethernet connection, to the search server 130 for processing. The search server 130 is operative to determine the given object queried in the web-based search, and to retrieve one or more available views associated with the identified object by querying the image server 140, which accesses structured object content stored on the image database 141. An object associated with a given search request may comprise, for example, an item, such as a motorcycle, cupcake, or football stadium.

The search server 130 then communicates with the contextual server 150 and the user-generated content server 160, respectively, for retrieving contextual data stored on the contextual database 151 and user-generated content stored on the user-generated content database 161 to complement the visual representation returned to the user. Contextual data may comprise general encyclopedic or historical information about the object, individual components of the object, demonstration materials pertaining to the object (e.g., a user manual, or training video), advertising or marketing information, or any other content related to the object. This information either be collected from offline resources or pulled from various online resources, with gathered information stored in an appropriate database. User-generated content may include, but is not limited to, product reviews (if the object is a consumer product), corrections to contextual data displayed along with the visual representation of the object (such as a correction to the historical information about the object), or advice regarding the object (e.g., how best to utilize the object, rankings), and the like.

The user-generated content server 160 and user-generated content database 161 may be further operative to capture any supplemental information provided by the user 110 and share supplemental information from other users within the network. Supplemental information may include, for example, corrections to visual representations of the object (e.g., an explanation by the user if the visual representation of the object is deformed), additional views of the object (that may be uploaded by the user) alternative visual representations of the object (e.g. a coke can may appear differently in disparate geographical regions, etc.) or user feedback (e.g., if the object is a consumer product). The user-generated content server not only serves as a repository to which users may upload their own content, but also as a system for aggregating content from different user generated content sources through out the Internet. The tracking server 170 records the search query response by the image server 140, the contextual server 150, and the user-generated content server 160. The search server 130 then returns the search results to the client device 120.

In more detail, the search server 130 receives search requests from a client device 120 communicatively coupled to the network 101. A client device 120 may be any device that allows for the transmission of search requests to the search server 130, as well as the retrieval of visual representations of objects and associated contextual data from the search server 130. According to one embodiment of the invention, a client device 120 is a general purpose personal computer comprising a processor, transient and persistent storage devices, input/output subsystem and bus to provide a communications path between components comprising the general purpose personal computer. For example, a 3.5 GHz Pentium 4 personal computer with 512 MB of RAM, 100 GB of hard drive storage space and an Ethernet interface to a network. Other client devices are considered to fall within the scope of the present invention including, but not limited to, hand held devices, set top terminals, mobile handsets, etc. The client device typically runs software applications, such as a web browser, that provide for transmission of search requests, as well as receipt and display of visual representations of objects and contextual data.

The search request and data are transmitted between the client device 120 and the search server 130 via the network 101. The network may either be a closed network, or more typically an open network, such as the Internet. When the search server 130 receives a search request from a given client device 120, the search server 130 queries the image server 140, the contextual server 150, and the user-generated content server 160 to identify one or more items of object content that are responsive to the search request that search server 130 receives. The search server 130 generates a result set that comprises one or more visual representations of an object along with links to associated contextual data relevant to the object view that falls within the scope of the search request. For example, if the user initiates a query for a motorcycle, the search server 130 may generate a result set that comprises an x-ray vision view exposing the inner workings of a motorcycle. If the user selects the x-ray vision view, then the associated contextual data may include the specifications of the visible individual components, such as, the engine, the gas tank, or the transmission. According to one embodiment, to present the user with the most relevant items in the result set, the search server may rank the items in the result set. The result set may, for example, be ranked according to frequency of prior selection by other users. Exemplary systems and methods for ranking search results are described in commonly owned U.S. Pat. No. 5,765,149, entitled “MODIFIED COLLECTION FREQUENCY RANKING METHOD,” the disclosure of which is hereby incorporated by reference in its entirety.

The search server 130 is communicatively coupled to the image server 140, the contextual server 150, and the user-generated content server 160 via the network 101. The image server 140 comprises a network-based server computer that organizes content stored in the image database 140. The image database 141 stores multiple types of data to present different views of objects. For example, if the object is a motorcycle, the image database 141 may contain data to present 360-degree angle surface views, three-dimensional outline rendering views, x-ray vision views exposing the inner workings, and blueprint views. These views can be stored as binary information, in three-dimensional file formats, bitmaps, JPEG's, or any other format recognizable by the client device 120 to display to the user 110. The image server may then organize these files by categorizing and indexing according to metadata, file name, file structure, ranking, interestingness or other identifiable characteristics.

After the different views are returned to the search server 130, the search server 130 then queries the contextual server 150, which organizes contextual data stored in the contextual database 151. The contextual server 150 identifies the object of the query and views returned to the search server 130, and retrieves contextual data from the contextual database 151 associated with the given object and/or views. According to one embodiment of the invention, the contextual data stored on the contextual database 151 may include encyclopedic data providing general information about the object, historical data providing the origins of the object and how it has evolved over time, ingredient/component data providing the make-up of the object with variable levels of granularity (e.g., down to the atomic level if desired), and demonstration mode data providing examples of how the object works and functions or how it may be utilized by the user 110. This information may be continually harvested or otherwise collected from source available on the Internet and from internal data sources. The contextual server 150 transmits the associated contextual data via the network 101 to the search server 130, which then presents the available contextual data in the result set to the client device 120.

Additionally, the search server 130 queries the user-generated content server 160 for user-generated content stored on the user-generated content database 161. The user-generated content may comprise content either uploaded or added by user 110 of the Omni search engine 100 that relates to the object of the search query. Such content may, for example, provide reviews of the object if it were a consumer product, or corrections to contextual data provided in the results displayed along with the visual representations of the object, or advice regarding the object (e.g., how best to utilize the object). The user-generated content server 160 and user-generated content database 161 thereby enable “wiki” functionality, encouraging a collaborative effort on the part of multiple users 110, by permitting the adding and editing of content by anyone who has access to the network 101. The user-generated content is retrieved by the user-generated content server 160, transmitted to the search server 130, and presented to the client device 120.

Concurrent to the processing of the results for the search query initiated by user 110, the tracking server 170 records the search query string and the results provided by the image server 140, the contextual server 150, and the user-generated content server 160. Additionally, the tracking server 170 records the visual representations, contextual data, and user-generated content selected by the user, along with subsequent searches performed in relation to the original search query. The tracking server 170 may be utilized for multiple purposes, for example, to improve of the overall efficiency of the Omni search engine 100 by organizing object content according to frequency of user selection, or in another embodiment, to monetize different elements of the retrieved results by recording page clicks and selling this information to advertisers.

A slightly modified embodiment of the Omni search engine 100 is illustrated in FIG. 1B. A mobile device 121 may, for example, be a cellular phone, a laptop computer, or a personal digital assistant. The mobile device 121 features image recording capability such as a digital camera or digital video camera. This enables the mobile device 121 to capture a digital image of an object 122 and transmit the image over the network 101 to the mobile application server 131. The mobile application server 131, which is communicatively coupled to the image recognition server 132 and the other components of the Omni search engine 100, transmits the digital image to the image recognition server 132.

The image recognition server 132 is comprised of hardware and software components that match the image of object 122 to a pre-defined term for an object that is recognized by the mobile application server 131. The image recognition server 132 does so by comparing the image of object 122 to image files located on the image recognition database 133. When the image recognition server 132 finds a match, it returns the pre-defined term result to the mobile application server 131. The mobile application server 131 then queries the image server 140, the contextual server 150, and the user-generated content server 160 to identify one or more items of object content that are responsive to the predefined term. The mobile application server 131 generates a result set that comprises one or more available visual representations of the object along with associated contextual data and user-generated content to the display on the mobile device 122. If the user 110 takes any such action recognizing the pre-defined term match of the image to be correct, the newly captured image of object 122 is added to the image recognition database 133. Such action may include, for example, clicking on or performing a “mouse-over” of the retrieved results. The newly captured image is then identified as an image of object 122 and is stored in the image recognition database 133 for future image-based object queries.

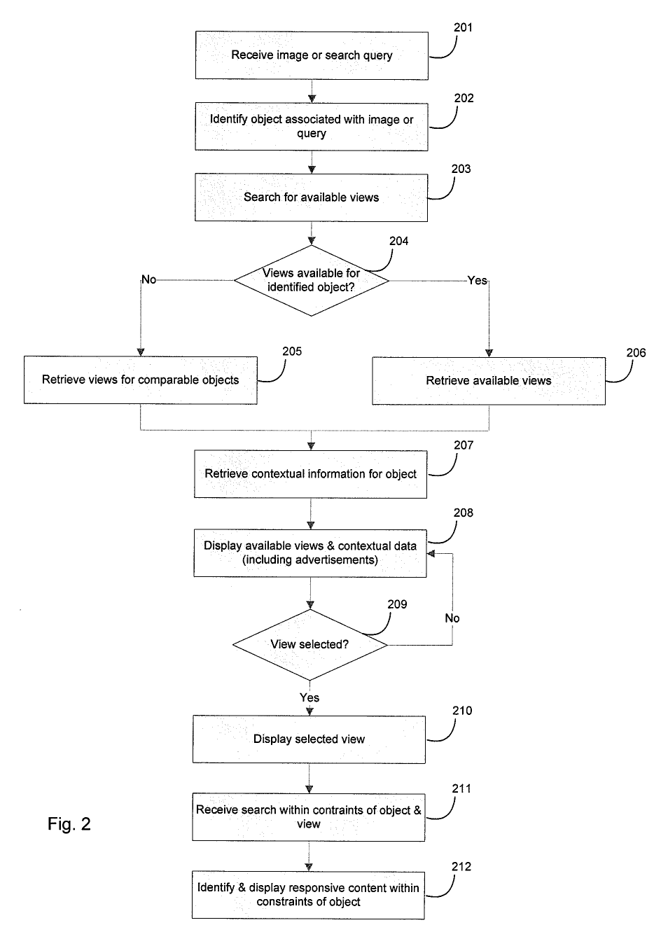

A method for using the system of FIG. 1A and FIG. 1B to search and retrieve visual representations or views and contextual data is illustrated in FIG. 2. According to the method of FIG. 2, a search query or image captured by a digital device, e.g., a mobile phone is received, step 201. The search query can be from a typical internet search where a user of a client device inputs a text string into a text box on a web page, the text string corresponding to the object that the user is searching for. The object is then identified according to the search query, step 202. Alternatively the object may be identified by recognition of a captured digital image from a mobile device, e.g., a mobile phone or laptop. The object is identified, step 202, by comparing the captured digital image to existing images of object. After the object is identified, step 202, available views for the object are searched for, step 203.

In another embodiment according to FIG. 2, a user is able to conduct a moving scan of an object. First, an image of the object is received from a mobile device with a camera and display as above, step 201, and the object is identified and associated with the image, step 202. The association step may include determining the distance between the mobile device and the object and/or the viewing angle through interpretation of the image. Among the available views searched for in this embodiment, step 203, is an option presented for a moving scan mode, which would enable available views to be retrieved, step 206, on a continuous basis correlating to the distance and positioning of the object. For example, a user may select a moving scan x-ray view of a pencil. The mobile device then records a continuous series of images of the pencil as the user moves the mobile device along the longitudinal plane of the pencil, and a correlating x-ray view of the object would be displayed.

If no views of the object are available, then views of comparable objects are retrieved. For example, if the object searched for was a Harley Davidson, and there are no available views of a Harley Davidson, step 204, views of a generic motorcycle, or a Kawasaki branded motorcycle may appear instead, step 205. Or, if the object searched for was a Kawasaki Ninja, Model 650R, and that specific model is not found, step 204, then a similar or related model may be returned, such as, the Kawasaki Ninja, Model 500R, step 205. If there are available views of the identified object, they are retrieved and presented on a display, step 206. Different types of views may be available, including, but not limited to, 360-degree angle surface views, three-dimensional outline rendering views, x-ray views to observe the innards of the object, and blueprint views to take accurate measurements and view the breakdown of the object's individual components. In all view modes, the user is able to view the object from a 360-degree view angle and zoom in or out of the view.

According to the embodiment illustrated in FIG. 2, in addition to the retrieved views, contextual information for the object is retrieved, step 207, and then subsequently displayed, step 208. Contextual data may include encyclopedic, historical, and demonstrative information, dimensions, weight, individual components of the object, and relevant advertising data. If the object was a motorcycle, for example, contextual data may include the history of the motorcycle as an invention, the size and weight of the specific motorcycle queried, the top speed and acceleration data, an individual component break-down, and pricing information. Additionally, contextual data may include relevant advertising content, correlating to the view and other contextual data presented. In the example of a motorcycle, such advertising content may include where to buy a new motorcycle, where to buy replacement parts for a motorcycle, where to find the closest motorcycle dealership, current motorcycle insurance promotions, and other motorcycle accessory merchant information.

Any of the available views and/or contextual data may be selected, and if done so, the subsequent view and/or data are displayed, step 210. If the user does not select a select any view or contextual data, the current display of available views and contextual data remains, step 208.

A new search may thereafter be conducted within the constraints of the object and view, step 211, according to the methods described herein. For example, where the displayed object is a Harley Davidson, the user may then conduct a search for a muffler or “mouse-over” the muffler on the displayed view. The component is then identified, step 212, and displayed as a new object with new available views and contextual data. Alternatively, if the object displayed is a pencil, the user may conduct a search for an eraser, or “mouse-over” the eraser on the displayed view. The eraser is identified, step 212, and displayed as a new object with new available views and contextual data relating specifically to the eraser.

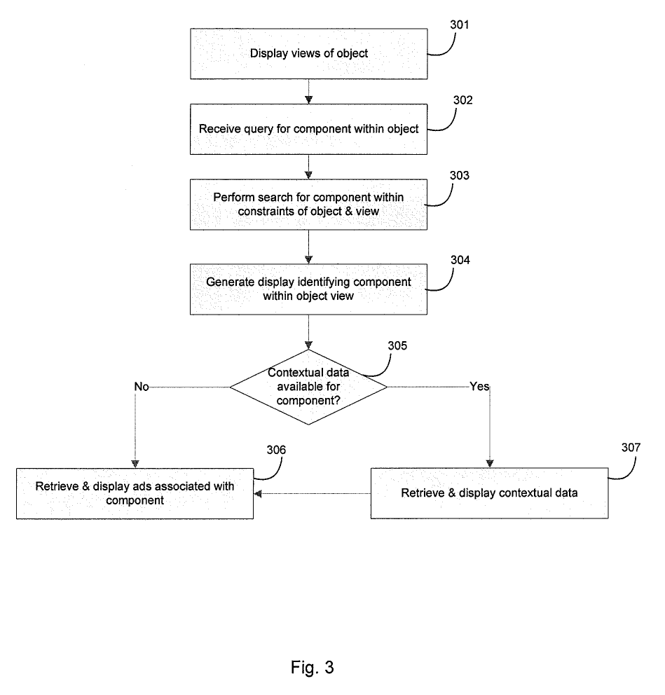

FIG. 3 is a flow diagram illustrating a method for searching for one or more components within the constraints of a given object, according to one embodiment of the present invention. One or more views of an object are displayed on a client or mobile device, step 301. As described above, such views may include three-dimensional renderings, and blueprint views. A query is then received for a component or ingredient within the confines of the object currently being displayed, step 302, and a search is performed for the component within the specified view of the object, step 303. Alternatively, if the component is not available in the currently displayed view, but is available in another view format, such view is then generated, step 304. Upon display of the component of the object, contextual data for the component is then retrieved, step 305. If such contextual data is available, it is displayed alongside the three-dimensional view of the component, step 307. For a bathroom in a stadium, such contextual data may include handicap-accessible facilities or the presence of a diaper-changing station. Additionally, relevant advertising content may be displayed alongside the three-dimensional view of the component, step 306, whether or not contextual data is available.

One example of the method in FIG. 3. is illustrated with the object being a Harley Davidson motorcycle. A three-dimensional wire-frame rendering is displayed on a client device, step 301. A query is then received for the phrase “seat cushion,” step 302, which is followed by a search for views of the seat cushion within the constraints of the wire-frame rendering of the current display, step 303. The seat cushion is then located within the wire-frame of the motorcycle and a display is generated identifying the seat cushion as such, step 304. In another embodiment, views of the seat cushion, such as two-dimensional photographs or photorealistic renderings, may be selected or displayed. Contextual data for the seat cushion is then retrieved and displayed alongside the view of the seat cushion, step 307. Such contextual data may include the physical properties of the seat cushion (e.g., leather or fabric), further components within the constraints of the seat cushion, and geographical indicators specifying where the seat cushion was made.

Advertising content is also displayed, correlating to the view and contextual data presented, step 306. In one specific embodiment, such advertising content may include where to buy new seat cushions, where to buy a new motorcycle, where to find the closest Harley Davidson dealership, motorcycle insurance promotions, and other motorcycle accessories.

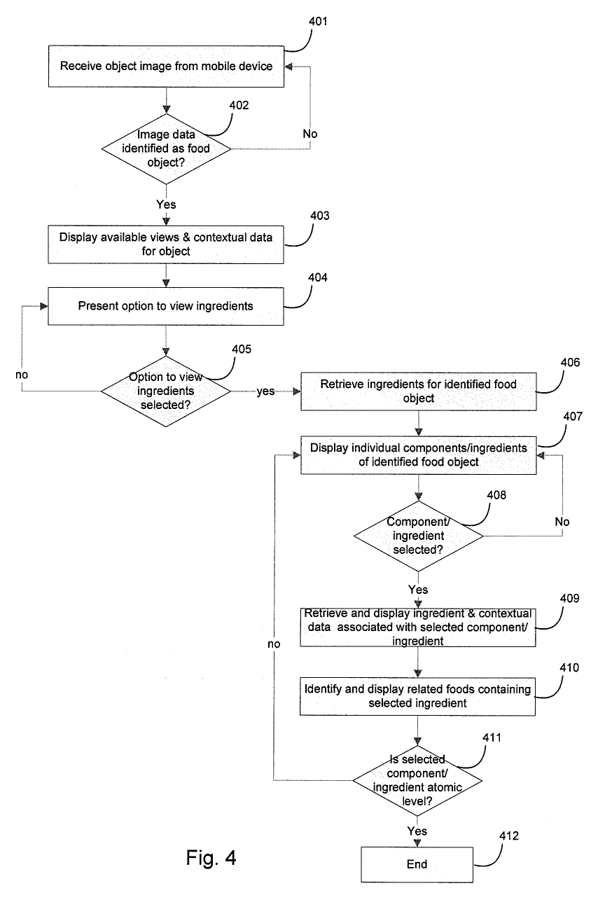

An alternative embodiment of the search method of FIG. 2 is illustrated in FIG. 4, which is a flow diagram presenting a method for identifying one or more components or ingredients comprising a given food object. In this embodiment, an image of a food object is received from a mobile device, step 401. For example, one such food object may be a captured two-dimensional image of a cupcake, or a slice of pizza. The image data is compared to a pre-existing images of food objects and then identified as a food object, step 402, and available views and contextual data for the food object are displayed, step 403. The two-dimensional image of a cupcake may, for example, be recognizable as a dessert, or cupcake, or a specific brand of cupcake, e.g., Entenmann's depending on the quality and depth of pre-existing images used for comparison. Contextual data for the cupcake may include the brand information, nearby bakeries, the history of cupcakes, and recipes for cupcakes.

Another specific type of contextual data for food objects may include an option to view the ingredients of the food object, step 404. If selected, the ingredients or components for the identified food object are retrieved, step 406, and displayed, step 407. In the present example, the cupcake's ingredients, such as eggs, flour, sugar, and sprinkles, would be displayed along with a complete breakdown of the nutritional facts of the cupcake, including, but not limited to, the fat, carbohydrate, protein, and caloric content.

A specific ingredient of the food object may thereafter be selected, step 408, and views of the ingredient and contextual data associated with the ingredient are displayed, step 409. For example, sprinkles of the cupcake may be selected, step 408, and then views of a sprinkle may be retrieved and displayed along with the one or more ingredients of a sprinkle and related nutritional facts, step 409. Views of a sprinkle may include a 360-degree angle surface view and three-dimensional outline rendering view. Advertising content, such as where to purchase sprinkles, or alternative brands of sprinkles, may accompany the display as additional contextual data. Other foods containing the selected ingredient may be identified and displayed according to one embodiment of the present invention, step 410. For example, doughnuts with sprinkles, or cake with sprinkles may be displayed alongside the view and contextual data of the sprinkle.

The method described in FIG. 4. allows for search functionality of the ingredients or components of food objects down to an atomic level. When an ingredient or component is retrieved and displayed, step 409, it is also determined whether the ingredient or component is at a fundamental or atomic level, step 411. If a given ingredient or component is not at an atomic level, then lower levels of ingredients or components may be selected. For example, the sprinkle may be comprised of sugar, dye, and a base ingredient. The sugar may be selected, step 408, and views and contextual data of sugar may be displayed, step 409. Such data may include the different types of simple sugars (e.g., fructose, glucose, galactose, maltose, lactose and mannose), or a breakdown between monosaccharides, disaccharides, trisaccharaides and oligosaccharides, along with their aldehyde or ketone groups. The disaccharide, fructose, may be selected, step 408, and then the individual components of the fructose, for example, the molecular compound C₁₂H₂₂O₁₁ is displayed, step 409. At the lowest level, carbon may be selected, step 408, and displayed, step 409, which may comprise the fundamental or atomic level, step 411.

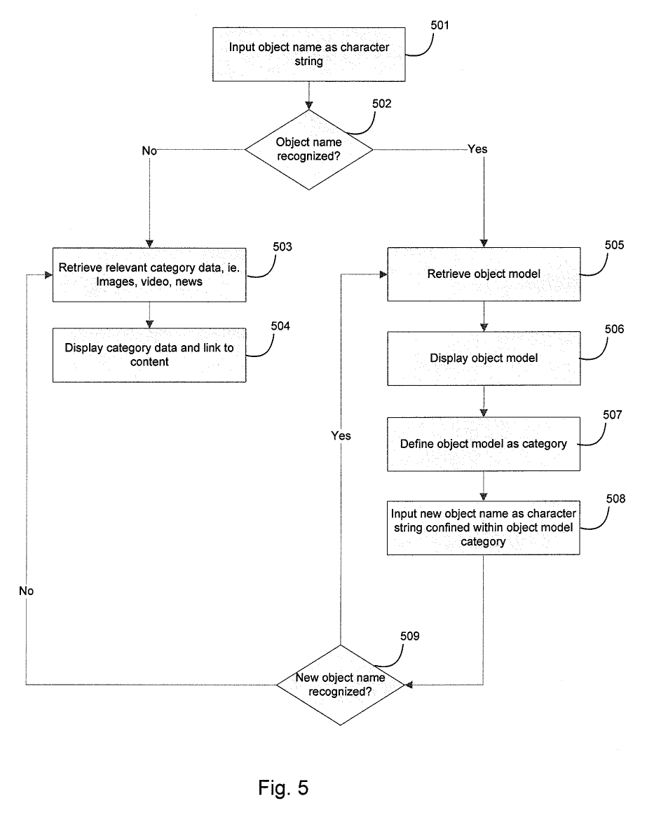

In another embodiment of the present invention, FIG. 5 illustrates a flow diagram presenting a method for web-based searching functionality embedded within an object-based search. A character string identifying a given object is received as a search query, step 501. Examples of such a character string may comprise a “motorcycle,” a “cupcake,” or a “football stadium.” If the object name is not recognized, step 502, a web-based search is run. Relevant category-based data is retrieved, such as hyperlinks to news content, images, video, and the like, step 503. This is similar in functionality to how traditional search engines such as, Yahoo!, operate. For example, under a Yahoo! search of “motorcycle,” links to such websites, including www.motorcycle.com, www.motorcycle-usa.com, en.wikipedia.org/wiki/Motorcycle, www.suzukicycles.com, and others, are displayed alongside sponsored links to websites, including www.harley-davidson.com, www.eBayMotors.com, hondamotorcycles.com, www.aperfectpartyzone.com (relating to an American Choppers Party), and others. News information, video, and image-based categories can also be selected, which provide more narrowly tailored content regarding the search of “motorcycle.” For example, if the news category is selected on a Yahoo search of “motorcycle,” links to news articles from various publications are provided, such as, “Clooney off hook in motorcycle crash, Boston Herald,” “Vandals ruin shrine for son killed in motorcycle crash, Arizona Republic,” and “Steven Tyler Launches Red Wing Motorcycle Company, Business Wire.”

However, if the object name is recognized, step 502, then the one or more available views of the object are retrieved, step 505. Available views may include 360-degree surface angle views, three-dimensional outline rendering views, x-ray vision views, blueprint views, and the like. According to one embodiment, a given view is displayed by default, step 506. Concurrently, the object model is defined as a category, step 507, within which a new object name may be inputted as a new character string query, step 508. For instance, in the example of the character string “motorcycle,” the object name motorcycle is recognized, step 502, and all available views of the motorcycle are retrieved, step 505. The 360-degree surface angle view may be displayed by default, step 506, and the “motorcycle” object is defined as a category, step 507. A new character string search for “seat cushion,” may then be conducted within the category of the object model for “motorcycle.” If the new character string query is not recognized as a new object, step 509, traditional search type results may be retrieved as previously described with respect to, step 503, and if the new character string query is recognized as an object, step 509, the new object model views are retrieved, step 505. Returning to the example of the “seat cushion” character string, if “seat cushion” is recognized within the category of “motorcycle,” step 509, then the object model for the “seat cushion” is retrieved, step 505, and a 360-degree surface angle view may be displayed, step 506. Alternative synonyms of the character string query may also be displayed to users, e.g. “bucket seats”, “seats”, “cushions”, “gel seats,” etc. However, if “seat cushion” is not recognized within the object model category of “motorcycle,” step 509, then a web-based search may retrieve relevant category data, step 503, for the character string, “seat cushion AND motorcycle,” and display links to related websites, step 504.

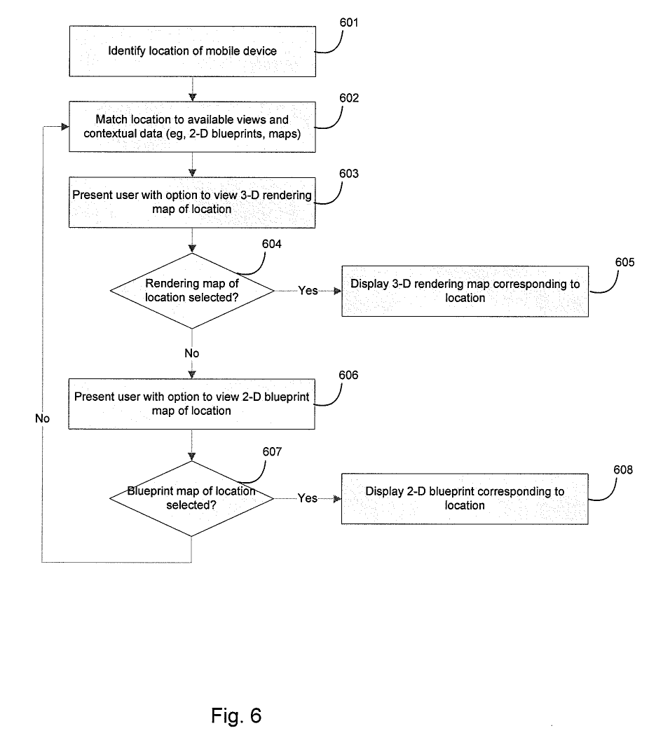

In yet another embodiment of the present invention, FIG. 6 depicts a flow diagram presenting a method for retrieving and displaying location-matching representations or views and contextual data. In FIG. 6, location is identified by a mobile device, step 601. Such a location may be a geographical reference point, a street corner, a football stadium or a museum, and such a device may include a cellular phone, or a GPS locator such as a Garmin. Location of the mobile device may be determined by satellite data relaying GPS coordinates, triangulation from cellular telephone towers, or any other available means. Next, the location identified in step 601 is matched to available views and contextual data, step 602. For example, if the location identified was a football stadium, available contextual data may include a blueprint of the stadium or means to locate the closest concession stand or bathroom.

An option is then presented to view a three-dimensional rendering map of the location, step 603, and if selected, step 604 a three-dimensional rendering map is displayed corresponding to the present location of the mobile device, step 605. For instance, if the mobile device is positioned at the entrance to a football stadium, available views of the entrance to the stadium would be matched to the location within the entrance to the stadium, step 602, and presented to the user with an option to view a three-dimensional rendering map of the entrance to the stadium, step 603. The user may be presented with contextual data related to the entrance, step 603, such as the nearest bathroom facilities, or directions to a specific seat. Additionally, contextual data relating to advertising content may be presented. Such advertising contextual data for a football stadium, for example, may include concession stand coupons, options to buy tickets to future sporting events, links to fan merchandise outlets, and the like.

If the rendering map is not selected, step 604, an option to view a two-dimensional blueprint or map of the current location corresponding to the present location of the mobile device is presented, step 607. In the case of a football stadium, for example, the map presented may be a stadium seating chart, or the like. If the blueprint or map is selected, step 607, it is displayed corresponding to the present location, step 608. In one embodiment, the location of the mobile device may be depicted by an indicator or marker in an overlay on the stadium seating chart. If the blueprint or map is not selected, available views and contextual data are continuously updated, step 602, after any detection of movement or change of location of the mobile device, step 601.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

We claim:

1. A method for searching and retrieving one or more visual representations and contextual data associated with a given object and one or more constituent components of the object, the method comprising:
receiving a first query identifying a given object;
identifying one or more visual representations and one or more items of contextual data corresponding to the given object;
displaying the one or more identified visual representations corresponding to the given object in conjunction with the one or more identified items of contextual data;
receiving a second query identifying a constituent component within the given object; and
identifying and displaying one or more visual representations of the constituent component in conjunction with one or more items of contextual data corresponding to the constituent component.

2. The method of claim 1 wherein receiving a first query comprises receiving one or more terms identifying a given object.

3. The method of claim 1 wherein receiving a first query comprises receiving an image from a mobile device identifying a given object.

4. The method of claim 1 wherein identifying one or more visual representations comprises identifying at least one of a three-dimensional view, blueprint view, x-ray view, outline view, three-dimensional rendering, and surface view.

5. The method of claim 1 wherein identifying contextual data comprises identifying at least one of historical information, specification information, encyclopedic information, and advertising information.

6. The method of claim 1 wherein identifying and displaying one or more visual representations of the constituent component comprises:
identifying the constituent component within the visual representation of the given object; and
displaying the identified constituent component in a distinguishing manner.

7. A system for searching and retrieving one or more visual representations and contextual data associated with a given object and one or more constituent components of the object, the system comprising:
an image server component operative to store one or more visual representations of one or more objects and one or more visual representations of one or more constituent components within the one or more objects; and
a contextual server component operative to store one or more items of contextual data for the one or more objects and the one or more constituent components within the one or more objects; and
a search server component operative to:
receive a first query identifying a given object;
retrieve and display one or more visual representations corresponding to the given object from the image server and one or more items of contextual data corresponding to the given object from the contextual server; and
receive a second query identifying a constituent component within the given object; and
retrieve and display one or more visual representations corresponding to the constituent component from the image server and one or more items of contextual data corresponding to the constituent component from the contextual server.

8. The system of claim 7 wherein the search server component is operative to receive a first query comprising one or more terms identifying a given object.

9. The system of claim 7 wherein the search server component is operative to receive a first query comprising an image from a mobile device identifying a given object.

10. The system of claim 7 wherein the image server component is operative to store one or more visual representations comprising at least one of a three-dimensional view, blueprint view, x-ray view, outline view, three-dimensional rendering, and surface view.

11. The system of claim 7 wherein the contextual server component is operative to store contextual data comprising at least one of historical information, specification information, encyclopedic information, and advertising information.

12. The system of claim 7 wherein the search server component is operative to:
identify the constituent component within the visual representation of the given object;
retrieve one or more visual representations corresponding to the constituent component from the image server and one or more items of contextual data corresponding to the constituent component from the contextual server; and
display the identified constituent component in a distinguishing manner.

13. Computer readable media comprising program code for execution by a programmable processor to perform a method for searching and retrieving one or more visual representations and contextual data associated with a given object and one or more constituent components of the object, the program code comprising:
program code for receiving a first query identifying a given object;
program code for identifying one or more visual representations and one or more items of contextual data corresponding to the given object;
program code for displaying the one or more identified visual representations corresponding to the given object in conjunction with the one or more identified items of contextual data;
program code for receiving a second query identifying a constituent component within the given object; and
program code for identifying and displaying one or more visual representations of the constituent component in conjunction with one or more items of contextual data corresponding to the constituent component.

14. The computer readable media of claim 13 wherein the program code for receiving a first query comprises program code for receiving one or more terms identifying a given object.

15. The computer readable media of claim 13 wherein the program code for receiving a first query comprises program code for receiving an image from a mobile device identifying a given object.

16. The computer readable media method of claim 13 wherein the program code for identifying one or more visual representations comprises program code for identifying at least one of a three-dimensional view, blueprint view, x-ray view, outline view, three-dimensional rendering, and surface view.

17. The computer readable media method of claim 13 wherein the program code for identifying contextual data comprises program code for identifying at least one of historical information, specification information, encyclopedic information, and advertising information.

18. The computer readable media of claim 13 wherein the program code for identifying and displaying one or more visual representations of the constituent component comprises:
program code for identifying the constituent component within the visual representation of the given object; and
program code for displaying the identified constituent component in a distinguishing manner.
